(19) United States
(12) Patent Application Publication
(10) Pub. No.: US 2006/0269024 A1
(43) Pub. Date: Nov. 30, 2006

(54) Initial multi-path acquisition of random access channels

(76) Inventors: Francis Dominique, Rockaway, NJ (US); Yi Hsuan, Whippany, NJ (US); Hongwei Kong, Denville, NJ (US)

Correspondence Address: HARNESS, DICKEY & PIERCE, P.L.C., P.O. BOX 8910, RESTON, VA, 20195, US

(21) Appl. No.: 11/138,362

(22) Filed: May 27, 2005

(51) Int. Cl. H04B 1/10

(52) U.S. Cl. 375/350

(57) ABSTRACT

A method may include determining whether to use a candidate path in acquiring a signal based on a path energy value at the candidate path and a path energy detection threshold. The path energy detection threshold may be less than a preamble detection threshold, and the preamble detection threshold may be used in detecting whether a candidate path carries a preamble.

### BACKGROUND OF THE INVENTION

1. Filed of the Invention

Example embodiments of the present invention relate to multipath acquisition for random access channels (RACHs) in a wireless network.

2. Description of the Conventional Art

In conventional Universal Mobile Telecommunications System (UMTS) networks, random access channels (RACHs) are transport channels, which carry data mapped from upper level logical channels (e.g., Open Systems Interconnect (OSI) Layers 3-7). Random access channels are transmitted by a user equipment (UE) to the Node-B in the uplink over physical channels such as physical random access channels (PRACHs). Physical random access channels are designated by, for example, a carrier frequency, scrambling code, channelization code, start and stop time, and/or relative phase (e.g., 0 or π/2). Start and stop time defines one or more time durations of messages and is measured in integer multiples of chips. Suitable multiples of chips are based on a radio frame, slot and/or sub-frame configuration.

A radio frame is a processing (or time) duration including, according to the UMTS standard, fifteen slots totaling 38400 chips in length. A slot is a processing (or time) duration, which is 2560 chips in length.

Conventionally, random access channels or propagation paths are used by one or more user equipments (UEs) to initiate access to the UMTS network.

FIG. 1 illustrates a high-level diagram of the UMTS architecture. Referring to FIG. 1, a UMTS architecture 100 comprises a radio access network part that may be referred to as a UMTS terrestrial radio access network (UTRAN) 150. The UTRAN 150 interfaces with a radio interface part 101, which includes user equipments such as mobile stations. The UTRAN 150 also interfaces with one or more core networks (CNs) 175 (only one being shown in FIG. 3 for simplicity) linking the radio network controller (RNC) with a Mobile Switching Center (MSC). Core network 175 further include mobile switching centers 180, serving GPRS support nodes (SGSNs) 185 and Gateway GPRS serving/support nodes (GGSNs) 188. SGSN 185 and GGSN 188 are gateways to external networks 190. In general in UMTS, SGSNs and GGSNs exchange packets with mobile stations over the UTRAN 150, and also exchange packets with other internet protocol (IP) networks, referred to herein as “packet data networks”. External networks 190 include various circuit networks 193 such as a Packet Switched Telephone Network (PSTN) or Integrated Service Digital Network (ISDN) and packet data networks 195. UTRAN 150 may also be linked to the core network 175 via back-haul facilities (not shown) such as T1/E1, STM-x, etc., for example. The UTRAN 150 includes cell sites, called Node-Bs 110, which serve a group of user equipments 105. A Node-B 110 may contain radio transceivers, which communicates with radio network controllers 115 in UTRAN 150.

Several Node-Bs 110 interface with a single radio network controller 115 where, in addition to call setup and control activity, tasks such as radio resource management and frame selection in soft handoff are carried out. Node-Bs 110 and radio network controllers 115 may be connected via links that use ATM-based packet transport, for example.

FIG. 2 illustrates a conventional protocol used by user equipment 105 to request access to the UMTS network 100, using a random access channel or propagation path. As shown in FIG. 2, a user equipment transmits a random access channel preamble, which may be 4096 chips in length to a serving Node-B (e.g., Node-B 110). Node-B 110 may be designated a serving Node-B for user equipment 105 if, for example, the Node-B 110 is capable of transmitting data to the user equipment 105. For exemplary purposes, we will assume that the Node-B 110 is a serving Node-B for the user equipment 105.

The energy of the random access channel, including a random access channel preamble, is determined based on the power level at which the random access channel preamble is transmitted.

An initial transmission power level for the random access channel preamble, and in turn an initial random access channel (or path) energy value, is determined by the user equipment in any well-known manner, for example, using a measured pilot power in the downlink from the serving Node-B 110 to the requesting user equipment 105.

After transmitting an initial random access channel preamble requesting access to the wireless network, the user equipment 105 waits a preamble-to-preamble time period (τₚ₋ₚ) for an acknowledgement (ACK) or a negative acknowledgement (NACK) from the Node-B 110, over a downlink acquisition indicator channel (AICH). If an acknowledgement is received in the downlink acquisition indicator channel within the preamble-to-preamble time period (τₚ₋ₚ), the user equipment 105 transmits a subsequent data message (e.g., 10 ms to 20 ms in duration) after a preamble-to-message time period (τₚ₋ₘ) elapses. The preamble-to-message time period (τₚ₋ₘ) is a time period beginning when a preamble is transmitted by the user equipment 105, and ending when a subsequent message is transmitted by the user equipment 105.

Alternatively, if the user equipment does not receive an acknowledgement over the downlink acquisition indicator channel within the preamble-to-preamble time period (τₚ₋ₚ), or the user equipment receives a negative acknowledgement over the downlink acquisition indicator channel, the user equipment 105 transmits another random access channel preamble with an increased transmission power level, and in turn an increased energy value. The transmission power may be increased using power ramping, in other words, increasing the preamble transmission power (e.g., using a power ramping step size).

The user equipment 105 then waits another iteration of the preamble-to-preamble time period (τₚ₋ₚ) for an acknowledgement from the serving Node-B 110 over the downlink acquisition indicator channel. The user equipment 105 may repeat this procedure until an acknowledgement is received from the Node-B 110 over the downlink acquisition indicator channel or the user equipment 105 reaches a maximum allowed number of random access channel preambles transmitted in one access attempt. If the user equipment 105 reaches the maximum number of attempts, the user equipment drops the attempt and restart from the beginning. The maximum number or attempts may be set, for example, by a human network operator, or via software implemented on a computer, at the Node-B 110.

FIG. 3 illustrates conventional processing of the random access channel by a preamble detector 302 and a message demodulator 304 at the serving Node-B 110. Initially, the preamble detector 302 attempts to detect the preamble transmitted from the user equipment 105. In attempting to detect the transmitted random access channel preamble, the preamble detector 302 compares the energy of each random access channel with an energy detection threshold value.

The energy detection threshold value is passed to the preamble detector 302 from a higher layer (e.g., the Radio Resource Control (RRC) layer, etc.), and is chosen such that the preamble detector 302 maintains a suitable preamble detection false alarm probability (e.g., smaller than a set value, which may also be provided by a higher layer). The preamble false alarm probability is a probability that a random access channel preamble is falsely detected, when in fact no random access channel preamble has been transmitted by a user equipment. For example, in conventional UMTS networks, a false alarm probability of smaller than 10⁻³ is suitable for a 10 Km cell.

If the energy of a random access channel passes (e.g., is greater than) the energy detection threshold value, the preamble detector 302 determines that a random access channel preamble has been transmitted and the user equipment (hereinafter referred to as the requesting user equipment) is requesting access to the UMTS network for transmitting a data message. The preamble detector 302 then sends a preamble indicator (e.g., an acknowledgement over the downlink acquisition indicator channel) to the user equipment, from which the preamble was transmitted, and concurrently reports the N random access channels (propagation or candidate paths) with an energy value greater than the energy detection threshold value to the random access channel message demodulator 304.

The random access channel message demodulator 304 then demodulates a subsequent data message transmitted by the requesting user equipment based on information received over the N reported random access channels. For example, the message demodulator 304 may demodulate the message using multi-path information provided by the random access channel preamble detector 302.

Alternatively, if the preamble detector 302 does not detect a random access channel with an energy level passing the energy detection threshold value, the preamble detector 302 determines that a random access channel preamble is not present, and the user equipment is not requesting access to the network.

In conventional preamble detection methods, in order to decrease the false alarm probability, the detection threshold value may be increased. However, this increase in the detection threshold value decreases the probability of detecting a random access channel preamble, and/or result in omission of additional useful candidate or propagation paths.

### SUMMARY OF THE INVENTION

In an example embodiment of the present invention, whether to use a candidate path in acquiring a signal may be determined based on a path energy value of the candidate path and a path energy detection threshold. The path energy detection threshold may be less than a preamble detection threshold used in detecting whether a candidate path carries a preamble.

In another example embodiment of the present invention, candidate paths may be filtered based on path energy values of the candidate paths and a path energy detection threshold to determine whether to use a candidate path in acquiring a signal if a preamble is detected in at least one of the candidate paths. The preamble may be detected based on at least one of the path energy values and a preamble energy detection threshold, which may be greater than the path energy detection threshold.

In example embodiments of the present invention, a candidate path may be used in acquiring a signal even if the candidate path's path energy value falls below the preamble energy detection threshold. Alternatively, in example embodiments of the present invention, the candidate path may be one of a plurality of candidate paths, and the determining may be performed if one of the candidate paths has an energy value above the preamble energy detection threshold.

Example embodiments of the present invention may further include calculating path energy values of a plurality of candidate paths, and detecting whether a preamble has been transmitted based on at least one of the calculated path energy values and the preamble energy detection threshold. In this example embodiment the determining may be performed if the detecting step detects a transmitted preamble.

In example embodiments of the present invention, the detecting may detect a preamble if at least one of the path energy values passes the preamble energy detection threshold.

In example embodiments of the present invention, the detecting may further include comparing at least one of the path energy values with the preamble energy detection threshold, and detecting a preamble if the path energy value passes the preamble energy detection threshold.

In example embodiments of the present invention, a preamble in the candidate path may be detected if a path energy values is greater than, or equal to, the preamble energy detection threshold.

In example embodiments of the present invention, the method may further include demodulating the signal based on the candidate path if the candidate is determined to be usable in acquiring the signal.

In example embodiments of the present invention, the method may further include generating a list of candidate paths, calculating path energy values for each of the candidate paths, ordering the list of candidate paths with respect to their corresponding path energy values, and detecting a transmitted preamble if the largest path energy value passes the preamble energy threshold value. In this example embodiments of the present invention, the determining may be performed if the detecting step detects a preamble.

In example embodiments of the present invention, the largest path energy value passes the preamble energy detection threshold if the largest path energy value is greater than, or equal to, the path energy detection threshold.

Example embodiments of the present invention may further include calculating path energy values for a plurality of candidate paths, detecting if a preamble has been transmitted based on at least one of the calculated path energy values and the preamble energy detection threshold.

In example embodiments of the present invention, the at least one of the path energy values may be compared to a path energy detection threshold, for example, from smallest to largest, each candidate path with a corresponding path energy value falling below the path energy detection threshold may be removed until one of the path energy values is determined to pass the path energy detection threshold, and the signal may be demodulated based on the candidate paths with path energy values greater than the path energy value passing the path energy detection threshold.

Example embodiments of the present invention may further include generating a list of candidate paths, calculating path energy values for each of the candidate paths, ordering, in descending order, the list of candidate paths with respect to the corresponding path energy values, and detecting a transmitted preamble based on the largest path energy value and a preamble energy threshold value.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a high-level diagram of the UMTS architecture;

FIG. 2 illustrates protocol for user equipment (UE) access using a random access channel (RACH);

FIG. 3 illustrates conventional processing of the random access channel (RACH) at a Node-B;

FIG. 4 is a flow chart illustrating a method, according to an example embodiment of the present invention; and

FIG. 5 is a flow chart illustrating a method, according to another example embodiment of the present invention.

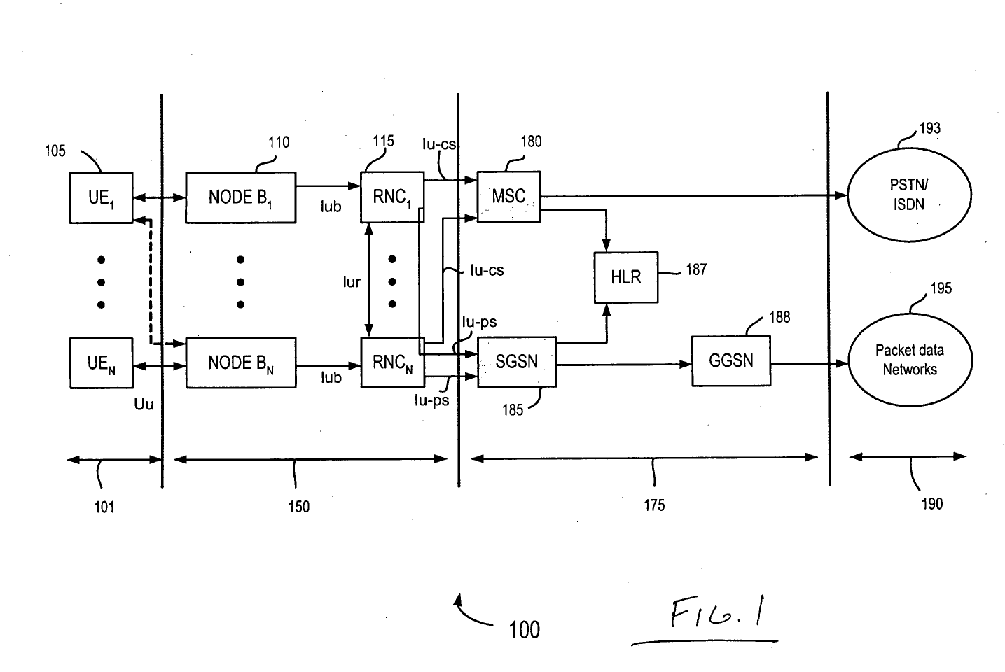

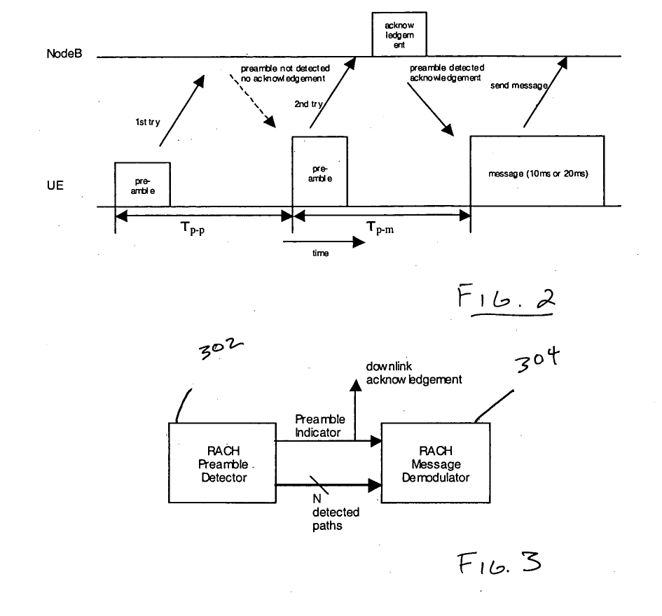

### DETAILED DESCRIPTION OF THE EMBODIMENTS

As described herein, Node-B may describe equipment that provides data connectivity between a packet switched data network (PSDN) such as the Internet, and one or more user equipments (UEs) (e.g., a base transceiver station (BTS), a base station, etc.). Additionally where used below, the term user equipment (UE) may describe a remote user of wireless resources in a wireless communication network (e.g., a user, subscriber, mobile station and remote station).

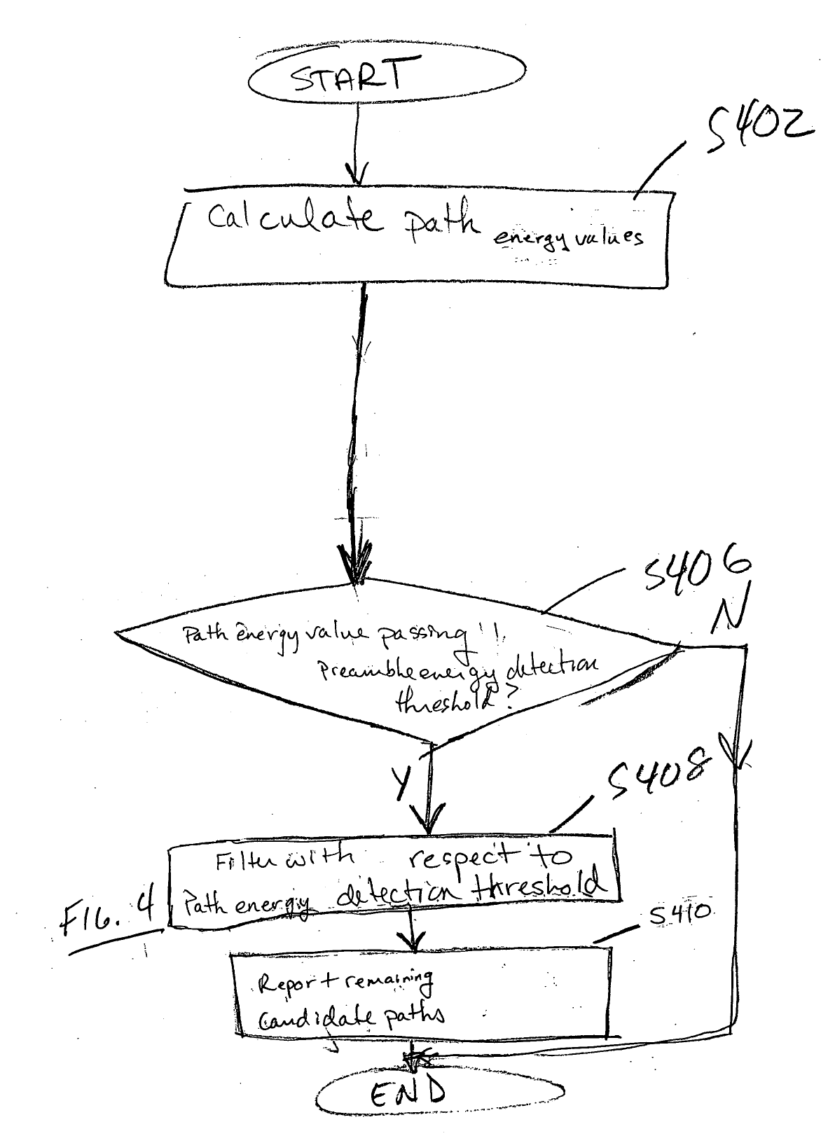

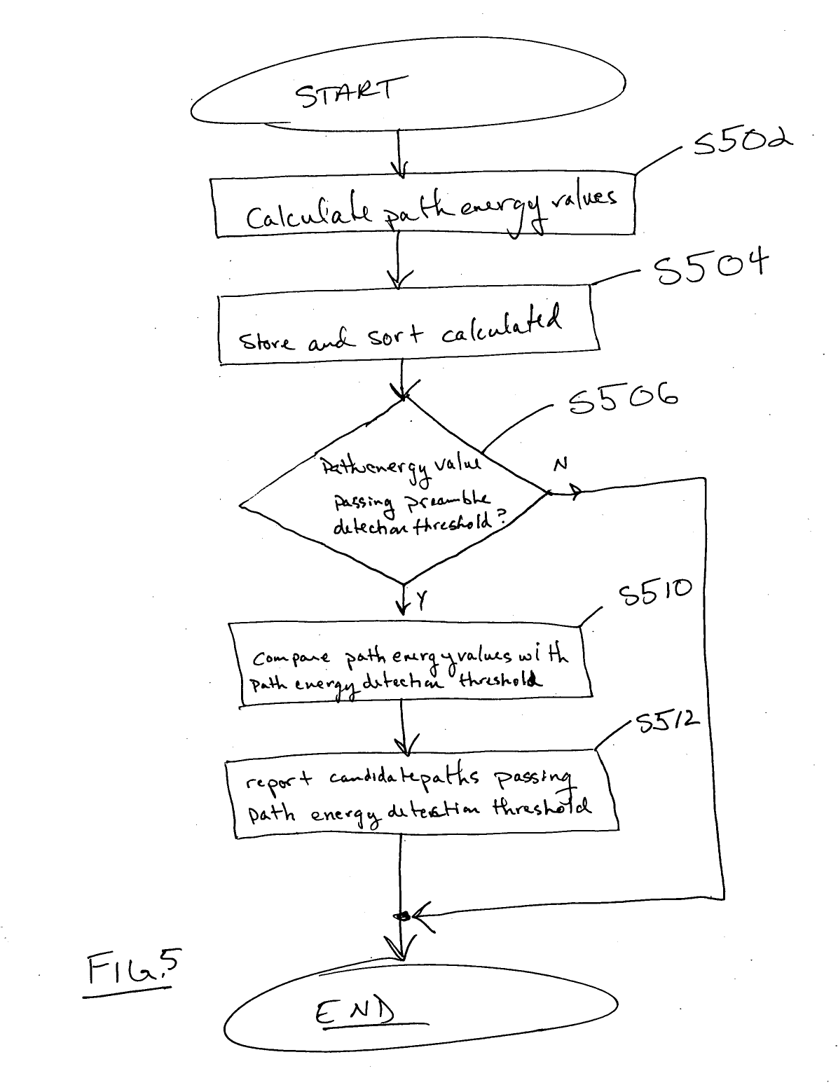

FIG. 4 is a flow chart illustrating a method, according to an example embodiment of the present invention, which may be performed for example, by the preamble detector 302 of FIG. 3. The preamble detector 302 may be included in, for example, a serving Node-B of a requesting user equipment, for example, Node-B 110 of FIG. 3. For exemplary purposes, the method illustrated in FIG. 4 will be discussed with respect to the block diagram of FIG. 3, including the preamble detector 302 and the message demodulator 304. However, it will be understood that example embodiments of the present invention are not limited to this implementation, and may be implemented, or used in conjunction with any suitable wireless network, Node-B, preamble detector, and/or message demodulator.

As discussed above, a random access transmission may include random access channel preamble transmission followed by random access channel data message transmission. Each random access channel preamble transmission may be 4096 chips in length and may include 256 repetitions of length 16 Walsh-Hadamard preamble sequence signatures, resulting in 16 signatures.

As also discussed above, random access channel preamble transmission(s) may be repeated with power ramping, in other words, increasing the preamble transmission power (e.g., using a power ramping step size), until the transmitting user equipment (e.g., the user equipment, which desires access to the UMTS network) receives an acknowledgement (ACK) from the serving Node-B in the downlink acquisition indicator channel (AICH). Initial uplink synchronization in a UMTS between the requesting user equipment and the serving Node-B may be achieved via random access channel preamble detection by the preamble detector 302.

At the serving Node-B, an initial search window for detecting one or more random access channel preambles may correspond to a round-trip delay between the serving Node-B and the requesting user equipment, performed at, for example, half-chip resolution. For example, upon receiving antenna data from the requesting user equipment at the serving Node-B, the serving Node-B may search for all possible propagation or candidate paths (e.g., random access channels, hereinafter referred to as paths) within its respective cell or coverage area. That is, the Node-B may search for all candidate paths over which a data message, transmitted from the requesting user equipment, may be received by the serving Node-B.

For example, for a 10 Km cell radius, a round trip delay may be 256 chips and the total number of candidate paths may be 256×2=512.

Returning to FIG. 4, after locating all candidate paths over which a signal or signals, transmitted by the requesting user equipment, may be received at the serving Node-B, the preamble detector 302 may calculate a path energy value for each candidate path, at step S402. In the example, as discussed above, the preamble detector 302 may calculate 512 path energy values.

The preamble detector 302 may then determine if a random access channel preamble has been transmitted by the requesting user equipment by determining whether a random access channel preamble exists in at least one of the 512 candidate paths. Namely, for example, the preamble detector 302 may compare each calculated path energy value to a preamble energy detection threshold, at step S406. If, at step S406, none of the calculated path energy values pass (e.g., are greater than, or equal to), the preamble energy detection threshold, the preamble detector 302 may determine that no random access channel preamble has been transmitted by the user equipment, and may not transmit an acknowledgement to the requesting user equipment on the acquisition indicator channel. The procedure may subsequently terminate.

Returning to step S406, if a calculated path energy for a candidate path is determined to pass (e.g., be greater than, or equal to), the preamble energy detection threshold, the preamble detector 302 may determine that a random access channel preamble is present (e.g., in the candidate path having the calculated energy value passing the preamble energy detection threshold). This indicates that a requesting user equipment is requesting access to the wireless network. Although discussed above with regard to a single candidate path, it will be understood that one or more candidate paths may have calculated energy values passing the preamble energy detection threshold. Furthermore, step S406 of FIG. 4 has been described with regard to the comparison of each calculated path energy value and the preamble detection threshold by the preamble detector 302. However, it will be understood that the preamble detector 302 may proceed to step S408, for example, immediately after determining that one of the calculated path energy values passes the preamble energy detection threshold. That is, for example, at step S406, if the first candidate path, which is compared to the preamble detection threshold, is determined to have a calculated energy value greater than, or equal to, the preamble detection threshold, the method of FIG. 4 may proceed to step S408 without comparing the remaining calculated path energy values.

Returning to FIG. 4, after determining that a random access channel preamble has been transmitted, the preamble detector 302 may filter the calculated path energy values with respect to a path energy detection threshold, at step S408. The path detection threshold may be determined at a higher layer, and may not be larger than the preamble threshold. For example, the path detection threshold may be determined via simulation and/or via field deployment. Similarly, the preamble threshold may also be passed to the preamble detector from a higher layer, however, its value may be chosen, for example, based on system performance requirements. In another example, the path energy detection threshold and/or the preamble energy detection threshold may be determined by a human network operator, for example, based on system performance requirements, the human network operator's knowledge base, and/or expertise.

For example, the preamble detector 302 may store all calculated path energy values and corresponding candidate paths in a list, which may be stored on any suitable storage medium, for example, a random access memory (RAM). The preamble detector 302 may then filter the list with regard to the path energy detection threshold. Namely, for example, the preamble detector 302 may remove from the list all candidate paths with calculated path energy values, which fall below the path energy detection threshold. That is, candidate paths with energy values less than the path energy detection threshold may be removed from the list. The candidate paths remaining in the list (e.g., the N strongest calculated path energy values passing the path energy detection threshold) may then be reported to the message demodulator 304, at step S410. These reported candidate paths may be used by the Node-B for receiving information (e.g., signals) regarding a subsequent data message transmitted by the user equipment. That is, for example, the Node-B may then receive a subsequent data message, for example, using information (e.g., signals) received over the reported candidate paths.

In example embodiments of the present invention, the preamble detector 302 may report at least a portion of, or all, candidate paths having calculated path energy values passing the path energy detection threshold to the message demodulator 304.

FIG. 5 is a flow chart illustrating a method, according to another example embodiment of the present invention, which may be performed, for example, by the preamble detector 302. As discussed above, the preamble detector 302, of FIG. 3, may be included in, for example, a serving Node-B.

As shown in FIG. 5, after locating candidate paths in a manner identical to that as described above, the preamble detector 302 may calculate a path energy value for each located candidate path, at step S502.

Similar to that as described above, the preamble detector 302 may calculate 512 path energy values. The preamble detector 302 may then generate a list including each calculated path energy value and corresponding candidate path, and sort the candidate paths in descending order with respect to their corresponding calculated path energy values, at step S504.

At step S506, after sorting the path energy values, the largest path energy value (e.g., the first path energy value in the list) may be compared with the preamble detection threshold value, as discussed above. If the largest path energy value does not pass (e.g., is less than) the preamble energy detection threshold, the preamble detector 302 may determine that no random access channel preamble has been transmitted and the procedure may terminate.

Returning to step S506, if the largest path energy values passes (e.g., is greater than, or equal to) the preamble energy detection threshold, the preamble detector 302 may determine that a random access channel preamble has been transmitted in the corresponding candidate path. The detected random access channel preamble may be indicative of a user equipment requesting access to the wireless network.

After detecting that a preamble has been transmitted, the preamble detector 302 may compare each of the calculated path energy values with a path energy detection threshold to determine which of the candidate paths are usable for receiving information (e.g., signals) regarding a subsequent data message from the user equipment at S510. Namely, for example, the preamble detector 302 may compare the smallest of the path energy values (e.g., the last path energy value in the list), and then sequentially compare each of the path energy values from smallest to largest until the preamble detector 302 detects a path energy value, which passes (e.g., is greater than, or equal to) the path energy detection threshold. The preamble detector 302 may then report the candidate paths in the list having path energy values greater than, or equal to, the path energy value passing the path energy detection threshold, to the message demodulator 304. That is, namely, the preamble detector 302 may report candidate paths position above the candidate path with a path energy value passing the path energy detection threshold.

For example, if the preamble detector 302 determines that the last path energy value in the list (e.g., the smallest path energy value) passes the path energy detection threshold, the preamble detector 302 may report candidate paths in the list to the message demodulator 304.

The reported candidate paths may then be used in receiving information (e.g., signals), which may be used in demodulating, combining, etc. one or more subsequent data messages transmitted from the user equipment.

As discussed above, in example embodiments of the present invention, the path detection threshold may be determined at a higher layer, and may not be larger than the preamble threshold. For example, the path detection threshold may be determined via simulation and/or via field deployment. Similarly, the preamble threshold may also be passed to the preamble detector from a higher layer, however, its value may be chosen, for example, based on system performance requirements.

Example embodiments of the present invention provide methods of initial multi-path acquisition for a random access channel, for example, used in 3GPP-UMTS uplink. However, it will be understood that example embodiments of the present invention may be implemented or used in conjunction with any suitable wireless communications channel, network, and/or network protocol.

Example embodiments of the present invention may provide more efficient use of useful propagation paths and/or may improve the random access channel message demodulator performance.

Although example embodiments of the present invention have been described based on a UMTS network infrastructure implementing a next generation Wideband Code Division Multiple Access (W-CDMA) air interface technology, it should be noted that example embodiments of the present invention shown and described herein are meant to be illustrative only and not limiting in any way.

As such, various modifications will be apparent to those skilled in the art. For example, it will be understood that the present invention finds application to any medium access control protocol with multiple modes in other spread spectrum systems such as CDMA2000 systems, other 3G systems and/or potentially developing fourth generation (4G) wireless communication systems.

The invention being thus described, it will be obvious that the same may be varied in many ways. Such variations are not to be regarded as a departure from the invention, and all such modifications are intended to be included within the scope of the invention.

We claim:

1. A method comprising:
determining whether to use a candidate path in acquiring a signal based on a path energy value of the candidate path and a path energy detection threshold, the path energy detection threshold being less than a preamble detection threshold used in detecting whether a candidate path carries a preamble.

2. The method of claim 1, wherein the determining step determines to use a candidate path having a path energy value, which falls below the preamble energy detection threshold, in acquiring a signal.

3. The method of claim 1, wherein the candidate path is one of a plurality of candidate paths, and the determining step is performed if one of the candidate paths has an energy value above the preamble energy detection threshold.

4. The method of claim 1, further comprising:
calculating path energy values of a plurality of candidate paths;
detecting whether a preamble has been transmitted based on at least one of the calculated path energy values and the preamble energy detection threshold; and wherein
the determining step is performed if the detecting step detects a transmitted preamble.

5. The method of claim 4, wherein the detecting step detects a preamble if at least one of the path energy values passes the preamble energy detection threshold.

6. The method of claim 4, wherein the detecting step further comprises:
comparing at least one of the path energy values with the preamble energy detection threshold; and
detecting a preamble if the path energy value passes the preamble energy detection threshold.

7. The method of claim 4, wherein the detecting step detects a preamble in the candidate path if a path energy values is greater than, or equal to, the preamble energy detection threshold.

8. The method of claim 1, further comprising:
demodulating the signal based on the the candidate path if the determining step determines that the candidate is usable in acquiring the signal;.

9. The method of claim 1, further comprising:
generating a list of candidate paths;
calculating path energy values for each of the candidate paths;
ordering, in descending order, the list of candidate paths with respect to their corresponding path energy values;
detecting a transmitted preamble if the largest path energy value passes the preamble energy threshold value; and wherein
the determining step is performed if the detecting step detects a preamble.

10. The method of claim 9, wherein the largest path energy value passes the preamble energy detection threshold if the largest path energy value is greater than, or equal to, the preamble energy detection threshold.

11. The method of claim 1, wherein the candidate path is determined to be usable in acquiring a signal if the path energy value passes the path detection threshold.

12. The method of claim 11, wherein the path energy value passes the path detection threshold if the path energy value is greater than, or equal to, the path energy detection threshold.

13. The method of claim 4, further comprising:
reporting each candidate path with a path energy value passing the path energy detection threshold; and
demodulating signals based on the reported candidate paths.

14. A method comprsing:
filtering candidate paths based on path energy values of the candidate paths and a path energy detection threshold to determine whether to use a candidate path in acquiring a signal if a preamble is detected in at least one of the candidate paths, the preamble being detected based on at least one of the path energy values and a preamble energy detection threshold, which is greater than the path energy detection threshold.

15. The method of claim 14, further comprising:
calculating path energy values for a plurality of candidate paths;
detecting if a preamble has been transmitted based on at least one of the calculated path energy values and the preamble energy detection threshold; and wherein
the filtering step is performed if the detecting step detects a preamble.

16. The method of claim 14, wherein the filtering step further comprises:
comparing at least one of the path energy values, from smallest to largest, and a path energy detection threshold;
removing each candidate path with a corresponding path energy value falling below the path energy detection threshold until one of the path energy values is determined to pass the path energy detection threshold; and
demodulating the signal based on the candidate paths with path energy values greater than the path energy value passing the path energy detection threshold.

17. The method of claim 14, further comprising:
generating a list of candidate paths;
calculating path energy values for each of the candidate paths;
ordering, in descending order, the list of candidate paths with respect to the corresponding path energy values;
detecting a transmitted preamble based on the largest path energy value and a preamble energy threshold value; and wherein
the filtering step is performed if the detecting step detects a preamble.

18. The method of claim 17, wherein the detecting step detects a preamble if the largest path energy value passes the preamble energy detection threshold.

19. The method of claim 17, wherein the detecting step further comprises:
comparing the largest path energy value with the preamble energy detection threshold; and
detecting a preamble if the largest path energy value is greater than, or equal to, the path energy detection threshold.

20. The method of claim 18, wherein the path energy value passes the preamble energy detection threshold if the path energy value is greater than, or equal to, the preamble energy detection threshold.
